(19) United States
(12) Patent Application Publication
(10) Pub. No.: US 2021/0241613 A1
(43) Pub. Date: Aug. 5, 2021

(54) METHODS AND SYSTEMS FOR PREDICTING TRAVEL TIME

(71) Applicant: BEIJING DIDI INFINITY TECHNOLOGY AND DEVELOPMENT CO., LTD., Beijing (CN)

(72) Inventors: Feng YI, Beijing (CN); Weili SUN, Beijing (CN); Jinqing ZHU, Beijing (CN)

(73) Assignee: BEIJING DIDI INFINITY TECHNOLOGY AND DEVELOPMENT CO., LTD., Beijing (CN)

(21) Appl. No.: 17/226,110

(22) Filed: Apr. 9, 2021

Related U.S. Application Data
(63) Continuation of application No. PCT/CN2018/123291, filed on Dec. 25, 2018.

(30) Foreign Application Priority Data
Nov. 16, 2018 (CN) 201811372599.6

(51) Int. Cl. G08G 1/01; G08G 1/056; G08G 1/097

(52) U.S. Cl. CPC G08G 1/0129; G08G 1/097; G08G 1/056

(57) ABSTRACT

The present disclosure discloses a method and system for predicting travel time. The method may include determining a stage of a first traffic signal light when an object enters a first traffic signal light intersection. The method may further include predicting a time length for the object to pass through the sub-road section at least based on the stage of the first traffic signal light; wherein a cycle of a traffic signal light includes at least two stages, and the sub-road section includes the first traffic signal light intersection. The process for prediction makes use of the stage of traffic signal lights when the object passes through the intersection, which makes the prediction more accurate.

### CROSS-REFERENCE TO RELATED APPLICATIONS

The application is a continuation of International Patent Application No. PCT/CN2018/123291, field on Dec. 25, 2018, which claims priority of Chinese Patent Application No. 201811372599.6 filed on Nov. 16, 2018, the contents of each of which is incorporated herein by reference.

### TECHNICAL FIELD

The present disclosure relates to data processing, in particular to a method and system for predicting travel time.

### BACKGROUND

With the development of the economy, there are more and more vehicles on the road. The increase of traffic volume and the increase of road complexity (e.g., the setting of traffic signal lights, intersections) have made more and more factors to be considered in the prediction of travel time of a vehicle. It is desired to provide systems and methods for predicting the travel time of a vehicle more accurately and effectively.

### SUMMARY

To achieve the above goals, the technical solutions provided by the present disclosure are as follows.

An aspect of the present disclosure provides a method for predicting travel time. The method may include at least one of the following operations. A stage of a first traffic signal light when an object enters a first traffic signal light intersection may be determined. A time length for the object to pass through a sub-road section may be predicted at least based on the stage of the first traffic signal light, wherein a cycle of a traffic signal light includes at least two stages, and the sub-road section includes the first traffic signal light intersection.

In some embodiments, the determining the stage of the first traffic signal light when the object enters the first traffic signal light intersection includes at least one of the following operations. The initial time of the object moving on the sub-road section and the cycle of the first traffic signal light may be obtained. The stage of the first traffic signal light when the object enters the first traffic signal light intersection may be determined at least based on the initial time and the cycle of the first traffic signal light.

In some embodiments, the starting point of the sub-road section is the first traffic signal light intersection, and the initial time is the time when the object enters the first traffic signal light intersection.

In some embodiments, the sub-road section further includes a second traffic signal light intersection, and predicting the time length for the object to pass through the sub-road section at least based on the stage of the first traffic signal light may include at least one of the following operations. The stage of the second traffic signal light when the object passes through the second traffic signal light intersection may be predicted based on the stage of the first traffic signal light. The time length for the object to pass through the sub-road section may be predicted at least based on the stage of the first traffic signal light and the stage of the second traffic signal light.

In some embodiments, a cycle of traffic signal light includes at least a red light stage and a green light stage. The method may further include at least one of the following operations. Prompt information may be sent in response to a prediction that the second traffic signal light is in the red light stage when the object passes through the second traffic signal light intersection, wherein the prompt information includes that the second traffic signal light is in the red light stage.

In some embodiments, based on the stage of the first traffic signal light, predicting the stage of the second traffic signal light when the object passes through the second traffic signal light intersection may include at least one of the following operations. Based on the stage of the first traffic signal light and one or more traffic signal light setting rules for setting the first traffic signal light and the second traffic signal light, the stage of the second traffic when the object passes through the second traffic signal light intersection may be predicted.

In some embodiments, a cycle of a traffic signal light includes at least a red light stage and a green light stage, and the green light stage includes at least an initial green light stage and a later green light stage. The method may further include at least one of the following operations. When the object enters the first traffic signal light intersection when the first traffic signal light is in the initial green light stage, that the second traffic signal light is in the green stage when the object passes through the second traffic signal light intersection may be predicted. In response to a determination that the first traffic signal light is in the later green light stage when the object enters the first traffic signal light intersection, that the second traffic signal light is in the red stage when the object passes through the second traffic signal light intersection may be predicted.

In some embodiments, the method may further include at least one of the following operations. The traffic state information of the sub-road section may be obtained. The traffic state information includes at least one of traffic jam information, historical trajectory data of objects on the sub-road section, or a movement speed of the object. The time length for the object to pass through the sub-road section may be predicted at least based on the stage of the first traffic signal light and the traffic state information.

In some embodiments, the method may further include at least one of the following operations. Historical traffic state information passing through a total road section may be obtained. The historical traffic state information includes at least one of historical traffic jam information, historical trajectory data of objects, a cycle of a traffic signal light, historical movement speeds of the objects, the historical travel time of the objects passing through the total road section. The total road section includes at least one sub-road section, and each sub-road section includes at least one traffic signal light intersection. A travel time prediction model may be determined based on the historical traffic state information. The travel time for the object to pass through the total road section may be predicted at least based on stages of the traffic signal lights when the object passes through each sub-road section and the travel time prediction model.

In some embodiments, the method may further include at least one of the following operations. The travel time prediction model may be dynamically updated at least based on the travel time for the object to pass through the total road section.

In some embodiments, the method may further include at least one of the following operations. The candidate movement trajectory of the object may be obtained. The sub-road section may be selected from the candidate movement trajectory based on the current movement trajectory of the object.

In some embodiments, the method may further include at least one of the following operations. The total road section may be divided into a plurality of sub-road sections, and at least one sub-road section of the plurality of sub-road sections includes at least one traffic signal light intersection. The travel time of the total road section may be predicted based on the travel time of each sub-road section.

In some embodiments, the method may further include at least one of the following operations. The travel time of the total road section may be dynamically updated.

Another aspect of the present disclosure provides a system for predicting travel time. The system includes a determination module and a prediction module. The determination module is configured to determine the stage of the first traffic signal light when the object enters the first traffic signal light intersection. The prediction module is configured to predict the time length for the object to pass through the sub-road section at least based on the stage of the first traffic signal light, wherein a cycle of a traffic signal light includes at least two stages, and the sub-road section includes the first traffic signal light intersection.

In some embodiments, the system further includes an obtaining module configured to obtain the initial time of the object moving on the sub-road section and the cycle of the first traffic signal light. The determination module is further configured to determine the stage of the first traffic signal light when the object enters the first traffic signal light intersection at least based on the initial time and the cycle of the first traffic signal light.

In some embodiments, the starting point of the sub-road section is the first traffic signal light intersection, and the initial time is the time when the object enters the first traffic signal light intersection.

In some embodiments, the sub-road section further includes a second traffic signal light intersection. The prediction module is further configured to predict the stage of the second traffic signal light when the object passes through the second traffic signal light intersection based on the stage of the first traffic signal light. The prediction module is further configured to predict the time length for the object to pass through the sub-road section at least based on the stage of the first traffic signal light and the stage of the second traffic signal light.

In some embodiments, the prediction module is further configured to predict the stage of the second traffic signal light when the object passes through the second traffic signal light intersection based on the stage of the first traffic signal light and the one or more traffic signal light setting rules for setting the first traffic signal light and the second traffic signal light.

In some embodiments, a cycle of a traffic signal light includes at least a red light stage and a green light stage. The system further includes a sending module configured to send prompt information in response to a prediction that the second traffic signal light is in the red light stage when the object passes through the second traffic signal light intersection, wherein the prompt information includes that the second traffic signal light is in the red light stage.

In some embodiments, a cycle of a traffic signal light includes at least a red light stage and a green light stage, and the green light stage includes at least an initial green light stage and a later green light stage. The prediction module is further configured to predict that the second traffic signal light is in the green stage when the object passes through the second traffic signal light intersection when the object enters the first traffic signal light intersection when the first traffic signal light is in the initial green light stage. In response to a determination that the first traffic signal light is in the later green light stage when the object enters the first traffic signal light intersection, that the second traffic signal light is in the red stage when the object passes through the second traffic signal light intersection may be predicted.

In some embodiments, the obtaining module is further configured to obtain traffic state information of the sub-road section. The traffic state information includes at least one of traffic jam information, historical trajectory data of objects on the sub-road section, or a movement speed of the object. The prediction module is further configured to predict the time length for the object to pass through the sub-road section at least based on the stage of the first traffic signal light and the traffic state information.

In some embodiments, the system further includes a training module for determining the travel time prediction model, and the determination method may include at least one of the following operations. Historical traffic state information passing through a total road section may be obtained. The historical traffic state information includes at least one of historical traffic jam information, historical trajectory data of objects of the total road section, a cycle of a traffic signal light, movement speeds of objects. The total road section includes at least one sub-road section, and each sub-road section includes at least one traffic signal light intersection. A travel time prediction model may be determined based on the historical traffic state information. The prediction module is further configured to predict the travel time of the object to pass through the total road section at least based on stages of the traffic signal lights when the object passes through each sub-road section and the travel time prediction model.

In some embodiments, the training module is further configured to dynamically update the travel time prediction model based on the travel time for the object to pass through the total road section.

In some embodiments, the obtaining module may be further configured to obtain a candidate movement trajectory of the object, and select the sub-road section from the candidate movement trajectory based on the current movement trajectory of the object.

In some embodiments, the obtaining module is further configured to divide the total road section into a plurality of sub-road sections, and at least one sub-road section of the plurality of sub-road sections includes at least one traffic signal light intersection. The prediction module is further configured to predict the travel time of the total road section based on the travel time of each sub-road section.

In some embodiments, the prediction module is further configured to dynamically update the travel time of the total road section.

Another aspect of the present disclosure provides a computer-readable storage medium that stores instructions, and at least one of the following operations may be performed when the instructions are executed. The stage of the first traffic signal light when the object enters the first traffic signal light intersection may be determined. The time length for the object to pass through the sub-road section may be predicted at least based on the stage of the first traffic signal light, wherein a cycle of a traffic signal light includes at least two stages, and the sub-road section includes the first traffic signal light intersection.

Another aspect of the present disclosure provides a device for predicting travel time. The device includes a processor, and at least one of the following operations is performed when the processor is running. The stage of the first traffic signal light when the object enters the first traffic signal light intersection may be determined. The time length for the object to pass through the sub-road section may be predicted at least based on the stage of the first traffic signal light. wherein a cycle of a traffic signal light includes at least two stages, and the sub-road section includes the first traffic signal light intersection.

Some additional features of the present disclosure may be explained in the following description. Some of the additional features of the present disclosure will be apparent to those skilled in the art from a review of the following description and the corresponding drawings, or of an understanding of the production or operation of the embodiments. The features disclosed by the present disclosure may be realized and achieved through the practice or use of various methods, means, and combinations of the specific embodiments described below.

### BRIEF DESCRIPTION OF THE DRAWINGS

The drawings described herein are configured to provide a further understanding of the present disclosure, all of which form a part of this specification. The exemplary embodiment(s) and the descriptions of the present disclosure are for the purpose of illustration only and are not intended to limit the scope of the present disclosure. In the drawings, the same reference numerals represent the same structures:

FIG. 1 is a schematic diagram illustrating an exemplary application scenario for predicting travel time according to some embodiments of the present disclosure;

FIG. 2 is a schematic diagram illustrating hardware components and/or software components of an exemplary computing device according to some embodiments of the present disclosure;

FIG. 3 is a block diagram illustrating functional modules of an exemplary travel time prediction system according to some embodiments of the present disclosure;

FIG. 4 is a flow chart illustrating an exemplary process for travel time prediction according to some embodiments of the present disclosure;

FIG. 5 is a flow chart illustrating an exemplary process for travel time prediction according to some embodiments of the present disclosure; and

FIG. 6 is a diagram illustrating an exemplary object movement trajectory according to some embodiments of the present disclosure.

### DETAILED DESCRIPTION

In order to illustrate the technical solutions related to the embodiments of the present disclosure, a brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

As used in the disclosure and the appended claims, the singular forms “a,” “an,” and “the” include plural referents unless the content clearly dictates otherwise. In general, the terms “comprise” and “include” merely prompt to include steps and elements that have been clearly identified, and these steps and elements do not constitute an exclusive listing. The methods or devices may also include other steps or elements.

Although the present disclosure makes various references to certain modules or units in the system according to the embodiments of the present disclosure, any number of different modules or units may be used and run on the client and/or server. The modules are merely illustrative, and different modules may be used for different aspects of the system and method.

A flowchart is used in the present disclosure to illustrate the operations performed by the system according to the embodiments of the present disclosure. It should be understood that the preceding or following operations are not necessarily performed exactly in order. Instead, the various steps may be processed in reverse order or simultaneously. At the same time, other operations may be added to these processes, or remove a step or several operations from these processes.

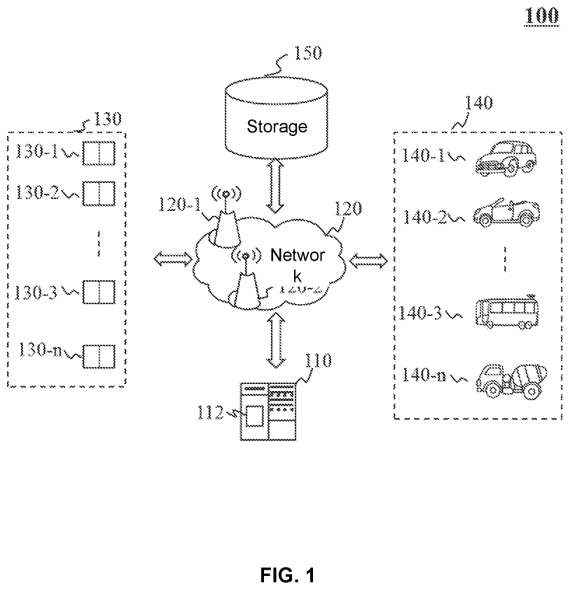

FIG. 1 is a schematic diagram illustrating an exemplary application scenario for predicting travel time according to some embodiments of the present disclosure. The exemplary application scenario 100 may include a server 110, a network 120, a traffic signal light 130, an object 140, and storage 150.

The server 110 may be a system that analyzes and processes collected information to generate analysis results. In some embodiments, the server 110 may analyze a stage (e.g., a red light stage, a green light stage) of the traffic signal light 130 (e.g., the traffic signal light 130-1) when the object 140 arrives at a previous traffic signal light intersection, and predict the stage of the traffic signal light 130 (e.g., the traffic signal light 130-2) when the object 140 arrives at s the next traffic signal light intersection. In some embodiments, the server 110 may analyze traffic jam information of a road, historical trajectory data of an object (e.g., historical trajectory data of a vehicle), the movement speed of the object 140, the stage of the traffic signal light 130 when the object 140 arrives at a traffic signal light intersection, etc., and then predict the time length for the object 140 to pass through a specific road section at a specific time. The server 110 may be a server or a server group. The server group may be centralized, such as a data center. The server group may also be distributed, such as a distributed system. The server 110 may be local or remote.

The server 110 may include an engine 112. The engine 112 may be configured to execute instructions (program codes) of the server 110. For example, the engine 112 may execute instructions of a program for predicting travel time, thereby predicting the time length for the object 140 to pass through a specific road section at a specific time. The program for predicting travel time may be stored in a computer-readable storage medium (e.g., the storage 150) in the form of computer instructions.

The network 120 may provide channels for information exchange. In some embodiments, the server 110, the traffic signal light 130, the object 140, and/or the storage 150 may exchange information through the network 120. For example, the server 110 may, through the network 120, obtain the geographic location of the traffic signal light 130, the stage of the traffic signal light 130 at a specific time, etc. As another example, the server 110 may obtain the geographic location and the movement speed of the object 140 through the network 120. As another example, the server 110 may obtain information from the storage 150 via the network 120 (e.g., the geographic location of the traffic signal light 130, historical trajectory data of objects).

The network 120 may be a single network or a combination of multiple networks. The network 120 may include a local area network, a wide area network, a public network, a private network, a wireless local area network, a virtual network, a metropolitan area network, a public switched telephone network, or the like, or a combination thereof. The network 120 may include a variety of network access points, such as wired or wireless access points, base stations (such as network 120-1, network 120-2), or network switching points, and data sources may be connected to the network 120 through the above-mentioned network access points and send information through the network.

The traffic signal light 130 may refer to a traffic signal light (i.e., a traffic signal light) installed at a road or an intersection. The traffic signal light 130 may include a plurality of phases. For example, the traffic signal light 130 may include three phases, such as a green light phase, a yellow light phase, and a red light phase. In some embodiments, a region or road may include a plurality of traffic signal lights 130, for example, a traffic signal light 130-1, a traffic signal light 130-2, a traffic signal light 130-3, . . . , a traffic signal light 130-n.

The object 140 refers to an object that may move on the road. For example, object 140 may include vehicles (e.g., cars, trucks, buses, trams, motorcycles, bicycles), people, robots, or the like. In some embodiments, a positioning device may be installed on the object 140, for example, a GPS positioning system. In some embodiments, the object 140 moving on the road may include an object 140-1, an object 140-2, an object 140-3, . . . , an object 140-n.

The storage 150 may refer to a device having a storage function. The storage 150 may be configured to store data related to the traffic signal light 130 and/or the object 140 and various data generated during the operation of the server 110. For example, the storage 150 may store the geographic location of the traffic signal light 130, the phase of the traffic signal light 130, and historical trajectory data of the object 140. The storage 150 may be local or remote. The connection or communication between the system database (e.g., the storage 150) and other modules of the system (e.g., the server 110, the object 140, the traffic signal light 130) may be wired or wireless. In some embodiments, the server 110 may directly access the data information stored in the storage 150, or directly access the information of the traffic signal light 130 and/or the object 140 through the network 120.

It should be noted that the description of application scenario 100 is for illustrative purposes and is not used to limit the protection scope of the present disclosure. For those skilled in the art, many variations and modifications may be made under the instructions of the present disclosure. However, these variations and modifications will not depart from the scope of protection of the present disclosure. For example, the storage 150 and the server 110 may be locally connected instead of being connected through the network 120.

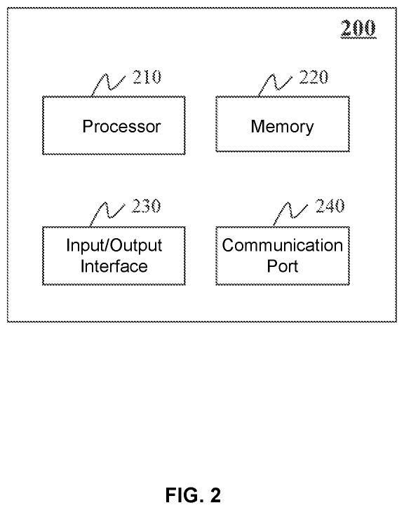

FIG. 2 is a schematic diagram illustrating hardware components and/or software components of an exemplary computing device according to some embodiments of the present disclosure. As shown in FIG. 2, the computing device 200 may include a processor 210, a memory 220, an input/output interface 230, and a communication port 240.

The processor 210 may execute calculation instructions (program code) and perform the functions of the server 110 described in the present disclosure. The calculation instructions may include programs, objects, components, data structures, procedures, modules, and functions (the functions refer to the specific functions described in the present disclosure). For example, the processor 210 may process the traffic jam information of a road in the application scenario 100, historical trajectory data of the object 140, the movement speed of the object 140, the stage of the traffic signal light 130 when the object 140 arrives at the traffic signal light intersection, and predict the time length for the object 140 to pass through a specific road section. As another example, the processor 210 may analyze the stage of the traffic signal light 130 when the object 140 passes through a previous traffic signal light intersection, and predict the stage of the traffic signal light 130 when the object 140 passes through the next traffic signal light intersection.

In some embodiments, the processor 210 may include a microcontroller, a microprocessor, a reduced instruction set computer (RISC), an application-specific integrated circuit (ASIC), an application-specific instruction-set processor (ASIP), a central processing unit (CPU), a graphics processing unit (GPU), a physical processing unit (PPU), a microcontroller unit, a digital signal processor (DSP), a field-programmable gate array (FPGA), an advanced RISC machine (ARM), a programmable logic device, and any circuit or processor that performs one or more functions, or a combination thereof. For illustration, the computing device 200 in FIG. 2 only describes one processor, but it should be noted that the computing device 200 in the present disclosure may also include multiple processors.

The memory 220 may store data/information obtained from any components in the application scenario 100, for example, related information (e.g., phase, period) of the traffic signal light 130, and the geographic location of the object 140. In some embodiments, the memory 220 may include mass memory, removable memory, volatile read and write memory, read-only memory (ROM), or the like, or a combination thereof. Exemplary mass memory may include magnetic disks, optical disks, solid-state drives, etc. Exemplary removable memory may include flash drives, floppy disks, optical disks, memory cards, compact disks, and magnetic tapes. Exemplary volatile read and write memory may include random access memory (RAM). The RAM may include dynamic RAM (DRAM), double-rate synchronous dynamic RAM (DDR SDRAM), static RAM (SRAM), thyristor RAM (T-RAM), and zero capacitance (Z-RAM). The ROM may include mask ROM (MROM), programmable ROM (PROM), erasable programmable ROM (PEROM), electrically erasable programmable ROM (EEPROM), compact disk ROM (CD-ROM), and digital universal disk ROM Wait.

The input/output interface 230 may be configured to input or output signals, data, or information. In some embodiments, the input/output interface 230 may enable an operator to communicate with the server 110. In some embodiments, the input/output interface 230 may include an input device and an output device. Exemplary input devices may include a keyboard, mouse, touch screen, microphone, or the like, or a combination thereof. Exemplary output devices may include display devices, speakers, printers, projectors, or the like, or a combination thereof. Exemplary display devices may include liquid crystal displays (LCD), light-emitting diode (LED) based displays, flat panel displays, curved displays, television equipment, cathode ray tubes (CRT), or the like, or a combination thereof.

The communication port 240 may be connected to a network for data communication. The connection may include a wired connection, a wireless connection, or a combination of both. The wired connections may include cables, optical cables, or telephone lines, or the like, or a combination thereof. The wireless connection may include Bluetooth, Wi-Fi, WiMax, WLAN, ZigBee, mobile networks (e.g., 3G, 4G, or 5G, etc.), or the like, or a combination thereof. In some embodiments, the communication port 240 may be a standardized port, such as RS232, RS485, or the like. In some embodiments, the communication port 240 may be specially designed.

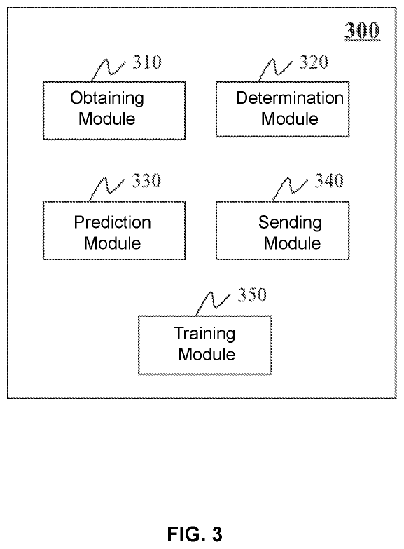

FIG. 3 is a block diagram illustrating functional modules of an exemplary travel time prediction system according to some embodiments of the present disclosure. The travel time prediction system 300 may include an obtaining module 310, a determination module 320, a prediction module 330, and a sending module 340.

The obtaining module 310 may obtain road sections and related information thereof, related information of the traffic signal light 130, and related information of the object 140.

In some embodiments, the obtaining module 310 may obtain road sections. The road section may include a road section to be predicted for travel time. As used herein, a travel time for a road section refers to a time length for an object (e.g., a vehicle) passing through the road section. The road section to be predicted may be a road section with a specific length, for example, 3 kilometers, or the road section to be predicted may be a road section with a specific travel time for the road section, for example, ten minutes. When the speed of the vehicle is a preset speed, the time length required for the vehicle to pass through the road section to be predicted may be equal to the specific travel time.

In some embodiments, the obtaining module 310 may obtain one or more candidate movement trajectories of the object 140, and then select the road section to be predicted from the candidate movement trajectories based on the current movement trajectory of the object 140. For example, the obtaining module 310 may obtain a candidate movement trajectory of the object 140, take the current position of the object 140 as a starting point, and determine at least a portion of the candidate movement trajectory with a preset length from the starting point as the road section to be predicted. The candidate movement trajectory may be a movement trajectory planned for the object 140 by the system 300 for predicting travel time, or the movement trajectory automatically planned by the object 140.

As another example, obtaining module 310 may obtain a candidate movement trajectory of the object 140, also referred to as a total road section. The obtaining module 310 may divide the total road section into a plurality of sub road sections, and at least one of the sub road sections may be used as a road section to be predicted. The sub-road section may include at least one traffic signal light intersection. In some embodiments, the starting point of the sub-road section may be a traffic signal light intersection. As used herein, a traffic signal light intersection refers to an intersection with a traffic signal light.

In some embodiments, the obtaining module 310 may obtain the related information of the road section, for example, traffic jam information, trajectory data of the object, speed limit information of the road section, etc. For example, the obtaining module 310 may obtain the traffic jam information of the road section at the current time or predict the traffic jam information in a future time period. As another example, the obtaining module 310 may obtain historical trajectory data and current trajectory data of objects moving on the road section. The traffic jam information may reflect the congestion situation of the road section. The traffic jam information may include traffic flow, a queuing length of vehicles on the road section, a queuing duration of the vehicles on the road section, a travel speed of vehicles on the road section, etc. The trajectory data of objects (e.g., trajectory data of vehicles) may reflect the object flow (e.g., the traffic flow) of the road section. Furthermore, the trajectory data of objects may reflect the congestion of the road section. The speed limit information may include the maximum speed and/or the minimum speed where the object 140 is allowed to pass through the road section.

In some embodiments, the obtaining module 310 may obtain the related information of the traffic signal light 130, for example, position information, phase, timing of each phase, period, etc. As used herein, the timing of a phase (e.g., a red light phase) of a traffic signal light refers to the duration of the phase. The timing of a traffic signal light refers to the total timing of all phases of the traffic signal light. The timing of a traffic signal light may also be referred to as a period of the traffic signal light. For example, the obtaining module 310 may obtain the geographic location of the traffic signal light 130 (e.g., latitude and longitude information). In some embodiments, the traffic signal light 130 may include three phases, such as a green light phase, a yellow light phase, and a red light phase. The timing of the three phases (e.g., the green light phase, the yellow light phase, and the red light phase) may be 30 seconds, 3 seconds, and 50 seconds, respectively. The timing (i.e., the period) of the traffic signal light 130 may be 83 seconds, that is (30+3+50) seconds. In some embodiments, the obtaining module 310 may determine the period of the traffic signal light 130 based on historical trajectory data of objects (e.g., travel speeds, stay time (or time length) at the traffic signal light 130, movement time at the traffic signal light 130, etc.) of objects passing through the road section. For example, the obtaining module 310 may perform statistical analysis on the historical trajectory data of objects passing through the road section within a week to determine the period of the traffic signal light 130. In some embodiments, the traffic signal light 130 may directly obtain the period of the traffic signal light 130 through an integrated traffic safety service platform. The transportation platform (i.e., the integrated traffic safety service platform) may be used as a platform for monitoring and controlling road traffic safety and providing services for vehicles.

In some embodiments, the obtaining module 310 may obtain the related information of the object 140, for example, time information, position information, and speed information. For example, obtaining module 310 may obtain an initial time when the object 140 starts to move on the road section to be predicted and the current time when the object 140 moves. As another example, obtaining module 310 may obtain the geographic locations (e.g., latitude and longitude information) and a movement trajectory (e.g., a historical movement trajectory) of the object 140. The movement trajectory of the object 140 may be composed of the multiple geographic locations of the object 140. As another example, obtaining module 310 may obtain the movement speeds of the object 140.

The determination module 320 may determine the stage of the traffic signal light 130. A cycle of a traffic signal light may include a plurality of phases. Each phase may reflect the progress of the cycle of the traffic signal light or period at a specific time. As used herein, a phase of the cycle of a traffic signal light refers to a portion of the cycle of the traffic signal light that indicates the same traffic rule or instruction. Different phases may correspond to different traffic rules or instructions.

To illustrate the stage of a traffic signal light, an example may be taken as follows. The cycle of the traffic signal light 130 may include three phases, such as a green light phase (also referred to as green light), a yellow light phase (also referred to as yellow light), and a red light phase (also referred to as red light), respectively. The corresponding timings of the green light, the yellow light, and the red light may be 30 seconds, 3 seconds, and 50 seconds, respectively. In some embodiments, each of one or more phases of the traffic signal light 130 may be divided into one or more stages. For example, the green light of the traffic signal light 130 may include an initial green light stage and a later green light stage. In some embodiments, the cycle of the traffic signal light 130 may be divided into one or more stages. For example, the cycle of the traffic signal light 130 may include four stages including an initial green light stage, a later green light stage, an initial red light stage, and a later red light stage. The initial green light stage may reflect that the progress of the cycle of the traffic signal light at a specific time is the initial stage of the green light phase. For example, the first 15 seconds of the green light phase may be designated as the initial stage of the green light phase. The later green light stage may reflect that the progress of the cycle of the traffic signal light at a specific time is the later green light stage of the green light phase. For example, the last 15 seconds of the green light phase may be designated as the later green light stage. The initial red light stage may reflect that the progress of the cycle of the traffic signal light at a specific time is the yellow light phase and/or the initial stage of the red light phase. For example, the 3 seconds of the yellow light phase and the first 24 seconds of the red light phase may be designated as the initial red light stage. The later red light stage may reflect that the progress of the cycle of the traffic signal light at a specific time is the later stage of the red light phase. For example, the last 26 seconds of the red light may be designated as the later red light stage.

In some embodiments, each of the phases of the traffic signal light 130 may correspond to one or more of the stages of the traffic signal light 130. For example, when the traffic signal light 130 is in the initial green light stage or the later green light stage, the phase of the traffic signal light 130 may be the green light phase. As another example, when the traffic signal light 130 is in the later red light stage, the phase of the traffic signal light may be the red light phase.

In some embodiments, one of the stages of the traffic signal light 130 may not correspond to one of the phases of the traffic signal light 130. For example, when the traffic signal light 130 is in the initial red light stage, the phases of the traffic signal light 130 may be in the yellow light phase or the red light phase.

It should be noted that the stages of the traffic signal light 130 are variable and may be divided according to specific rules. The meaning of each stage may be variable and may be defined according to specific rules. In some embodiments, the stages of the traffic signal light 130 (also referred to as the stages of the cycle of the traffic signal light 130) may be divided according to historical trajectory data (e.g., vehicles or pedestrians). In some embodiments, the cycle of the traffic signal light 130 may include three stages, such as a red light stage, an initial green light stage, and a later green light stage. In some embodiments, the initial green light stage and the later green light stage may be collectively referred to as a green light stage.

It should be understood that when the cycle of the traffic signal light 130 is divided into specific stages, a specific time may correspond to a specific stage. Then, the determination module 320 may determine the stage of the traffic signal light 130 at the current time or a time when a specific behavior occurs. For example, the determination module 320 may determine the stage of the traffic signal light 130 when the object 140 arrives or enters the traffic signal light intersection. As used herein, the object 140 arriving or entering the traffic signal light intersection refers to that the object 140 arrives or enters a range of the traffic signal light intersection. The range of the traffic signal light intersection may include a predetermined range (e.g., three hundred meters) of a road where the traffic signal light intersection is located. For example, the range within 300 meters from a stop line of the intersection may be considered to belong to the intersection. As another example, a range extending 300 meters outward from the center of the intersection may be considered to belong to the intersection. As still another example, the range determined by one or more traffic indication lines on the road where the intersection is located may be considered to belong to the intersection, such as an area enclosed by the stop lines of a crossroad in four directions may be considered to be belonged to the intersection. The above descriptions for the intersection are only exemplary illustrations of the intersection, and should not be considered as a limitation on the definition of the intersection. In other embodiments, the specific range of the intersection may be set according to actual needs. For example, the range may be 10 meters, 50 meters, 100 meters, 150 meters, 200 meters, etc.

As described above, the determination module 320 may determine the stage of the traffic signal light 130 when the object 140 enters the traffic signal light intersection at least based on the initial time when the object 140 starts to move on the road section to be predicted. For example, the determination module 320 may predict the required time for the object 140 to enter the traffic signal light intersection from the initial position of the road section to be predicted based on the current movement speed of the object 140 and the distance between the current position of the object 140 and the traffic signal light intersection. Combined with the initial time when the object 140 starts to move on the road section to be predicted, the determination module 320 may predict the time when the object 140 enters or arrives at the traffic signal light intersection. Then, the determination module 320 may determine the stage of the traffic signal light 130 based on the time when the object 140 enters or arrives at the traffic signal light intersection. For example, when the object 140 enters or arrives at a traffic signal light intersection, it is 10:00 am, and the cycle of the traffic signal light 130 is 1 minute. Assuming that the phase of the traffic signal light in one cycle changes from the green light to the yellow light, and from the yellow light to the red light, then the traffic signal light is in the initial stage of the green light (also referred to as the initial green light stage).

In some embodiments, the starting point of the road section to be predicted (e.g., the sub-road section mentioned above) may be a traffic signal light intersection. Then, the initial time when the object 140 starts to move on the road section to be predicted is the time when the object 140 enters the traffic signal light intersection. At this time, the determination module 320 may determine the stage of the traffic signal light 130 only based on the initial time when the object 140 starts to move on the road section to be predicted. The determination of the stage of the traffic signal light 130 may refer to the above example.

The prediction module 330 may predict the time length for the object 140 to pass through the road section to be predicted at least based on the stage of the traffic signal light 130 when the object 140 enters the traffic signal light intersection. The road section to be predicted may include the traffic signal light intersection.

For the purpose of illustration, the time length for the object 140 to pass through the road section to be predicted may be divided into a time length for the object 140 to pass through a traffic signal light intersection of the road section to be predicted and a time length for the object 140 to pass through a region without the traffic signal light intersection of the road section to be predicted. The region without the traffic signal light intersection of the road section to be predicted may also be referred to as a range of the road section except for the range of the traffic signal light intersection. Furthermore, the prediction module 330 may predict the time length for the object 140 to pass through the road section to be predicted by predicting the time length for the object 140 to pass through the traffic signal light intersection and the time length for the object 140 to pass through the region of the road section except the traffic signal light intersection to be predicted.

In some embodiments, the road section to be predicted may include one single traffic signal light intersection. The prediction module 330 may predict the time length for the object 140 to pass through the traffic signal light intersection on the road section to be predicted based on the stage of the traffic signal light when the object 140 enters the traffic signal light intersection. For example, when the object 140 enters the traffic signal light intersection, the traffic signal light may be in the green light stage (e.g., the green light initial stage, the later green light stage), the object 140 may directly pass through the traffic signal light intersection without stopping. The prediction module 330 may predict the time length for the object 140 to pass through the traffic signal light intersection based on the distance between the geographical position of the object 140 when the object 140 enters the traffic signal light intersection and the geographical position of the object 140 when the object 140 leaves the traffic signal light intersection (denoted as S1) and the movement speed of the object 140 (denoted as V). As another example, when the object 140 enters the traffic signal light intersection, the traffic signal light may be in the initial red light stage or the later red light stage, and the object 140 may not directly pass through the traffic signal light intersection and need to wait for a period (denoted as tw). The prediction module 330 may predict the time length for the object 140 passing through the traffic signal light intersection based on S1, V, and tw.

In some embodiments, the road section to be predicted may include two traffic signal light intersections, denoted as a first traffic signal light intersection and a second traffic signal light intersection. The prediction module 330 may predict the time length for the object 140 to pass through the first traffic signal light intersection based on the stage of the first traffic signal light when the object 140 enters the first traffic signal light intersection. Further, the prediction module 330 may predict the stage of the second traffic signal light when the object 140 enters the second traffic signal light intersection based on the stage of the first traffic signal light when the object 140 enters the first traffic signal light intersection. Then, the prediction module 330 may predict the time length for the object 140 to pass through the second traffic signal light intersection based on the stage of the second traffic signal light when the object 140 enters the second traffic signal light intersection. Based on the time lengths for the object 140 to pass through the first traffic signal light intersection and the second traffic signal light intersection, the prediction module 330 may predict the time length for the object 140 to pass through the road section to be predicted.

In some embodiments, the road section to be predicted may include three or more traffic signal light intersections, denoted as a first traffic signal light intersection, a second traffic signal light intersection, a third traffic signal light intersection, . . . , an (N−1)th traffic signal light intersection, Nth traffic signal light intersection. The prediction module 330 may predict the stage of the second traffic signal light when the object 140 enters the second traffic signal light intersection based on the stage of the first traffic signal light when the object 140 enters the first traffic signal light intersection. The prediction module 330 may predict the stage of the third traffic signal light when the object 140 enters the third traffic signal light intersection based on the stage of the second traffic signal light when the object 140 enters the second traffic signal light intersection. By analogy, the prediction module 330 may predict the stage of the Nth traffic signal light when the object 140 enters the Nth traffic signal light intersection based on the stage of the (N−1)th traffic signal light when the object 140 enters the (N−1)th traffic signal light intersection. The prediction module 330 may predict the time length for the object 140 to pass through each traffic signal light intersection based on the stage of the each traffic signal light when the object 140 enters the traffic signal light intersection, and then predict the time length for the object 140 to pass through the road section to be predicted.

In the above-mentioned embodiments, the prediction module 330 may use a variety of processes to predict the time length for the object 140 to pass through each traffic signal light intersection. For example, the prediction module 330 may predict the time length (denoted as t1) for the object 140 to pass through a distance based on the distance between a geographic location of the object 140 entering the traffic signal light intersection (i.e., the geographic location when the object 140 enters the range of the traffic signal light intersection) and the geographic location of the object 140 leaving the traffic signal light intersection (i.e., the geographic location when the object 140 leaves the range of the traffic signal light intersection) and the current speed of the object 140. The prediction module 330 may predict the waiting time length of the object 140 (denoted as t2) according to the stage of the traffic signal light when the object enters the traffic signal light intersection. Based on t1 and t2, the prediction module 330 may predict the time length for the object 140 to pass through the traffic signal light intersection.

As mentioned above, a specific time may correspond to a specific stage of a traffic signal light. In some embodiments, the prediction of a stage of a traffic signal light (also referred to as a next traffic signal light) when the object 140 enters a traffic signal light intersection (denoted as a next traffic signal light intersection) based on the stage of another traffic signal light (denoted as a previous traffic signal light) when the object 140 enters a previous traffic signal light intersection may be equivalent of predicting the time when the object 140 enters the next traffic signal light intersection based on the time when the object 140 enters the previous traffic signal light. For example, the prediction module 330 may predict the time length required for the object 140 to move from the previous traffic signal light intersection to the next traffic signal light intersection based on the current speed (or predicted speed) of the object 140 and the distance between the two traffic signal light intersections. Combined with the time when the object 140 enters the previous traffic signal light intersection and the predicted time length for the object 140 to pass through the previous traffic signal light intersection, the prediction module 330 may predict the time when the object 140 enters the next traffic signal light intersection. Furthermore, the prediction module 330 may predict the stage of the next traffic signal light when the object 140 enters the next traffic signal light intersection.

In some embodiments, multiple traffic signal lights 130 may be set according to specific one or more traffic signal light setting rules. For example, two consecutive or adjacent traffic signal lights 130 on the road, denoted as a previous traffic signal light (e.g., the first traffic signal light) and a next traffic signal light (e.g., the second traffic signal light), may be set according to specific one or more traffic signal light setting rules. The one or more traffic signal light setting rules may reflect the phases of the traffic signal light, the timing of each phase of the traffic signal light, and the corresponding relationships between progresses of the cycles of the different traffic signal lights at the same time (e.g., the stage of the traffic signal light). Then, the prediction module 330 may predict the stage of the traffic signal light when the object 140 enters the traffic signal light intersection according to the one or more traffic signal light setting rules.

For example, the one or more traffic signal light setting rules may be that both of the first traffic signal light and the second traffic signal light may include three phases, such as a green light phase, a yellow light phase, and a red light phase. When the first traffic signal light is in the initial green light stage, the second traffic signal light may be in the later green light stage. When the first traffic signal light is in the later green light stage, the second traffic signal light may be in the initial red light stage. When the object 140 moves at a preset speed, the prediction module 330 may perform the following predictions. When the object 140 passes through the first traffic signal light intersection and the first traffic signal light is in the initial green light stage, the second traffic signal light may be in the green light stage when the object 140 enters the second traffic signal light intersection. When the object 140 passes through the first traffic signal light intersection and the first traffic signal light is in the later green light stage, the second traffic signal light may be in the red light stage when the object 140 enters the second traffic signal light intersection. In some embodiments, the preset speed of the object 140 may be an average speed of all vehicles on the road section at a specific time, or an average speed within the speed limit range of the road section (e.g., the average value of the maximum speed limit and the minimum speed limit).

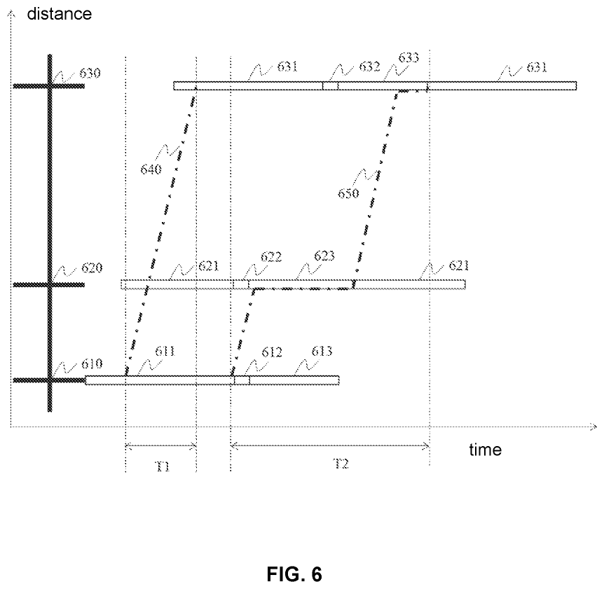

In order to illustrate the influence of the stage of the traffic signal light 130 when the object 140 enters a traffic signal light intersection on the time length for the object 140 to pass through the traffic signal light intersection, an example with FIG. 6 may be taken as follows.

FIG. 6 is a diagram illustrating an exemplary movement trajectory of an object according to some embodiments of the present disclosure. As shown in FIG. 6, the abscissa denotes time, and the ordinate denotes distance. FIG. 6 shows multiple object movement trajectories denoted by dotted lines, for example, movement trajectory 640 and movement trajectory 650.

The movement trajectory 640 describes the movement trajectory formed by a first object moving from a first traffic signal light intersection 610, passing through the second traffic signal light intersection 620, to the third traffic signal light intersection 630. The movement trajectory 650 describes a movement trajectory formed by a second object moving from the first traffic signal light intersection 610, passing through the second traffic signal light intersection 620, to the third traffic signal light intersection 630. The movement speed of the first object and the second object may be the same or equivalent, and both may be within the preset speed range.

A first traffic signal light installed at the first traffic signal light intersection 610 may have three phases, namely a green light phase 611, a yellow light phase 612, and a red light phase 613. A second traffic signal light installed at the second traffic signal light intersection 620 may have three phases, namely a green light phase 621, a yellow light phase 622, and a red light phase 623. A third traffic signal light installed at the third traffic signal light intersection 630 may have three phases, namely a green light phase 631, a yellow light phase 632, and a red light phase 633.

The traffic signal lights at the first traffic signal light intersection 610, the second traffic signal light intersection 620, and the third traffic signal light intersection 630 may be set up according to certain one or more traffic signal light setting rules. When the first object passes through the first traffic signal light intersection 610, and the first traffic signal light is in the green light 611 (i.e., the initial green light stage), the second traffic signal light may be in the green light 621 (i.e., the green light stage) when the first object passes through the second traffic signal light intersection 620, and the third traffic signal light may be in the green light 631 (i.e., the green light stage) when the first object passes through the third traffic signal light intersection 630. At this time, the travel time length for the first object traveling along the movement trajectory 640 may be T1. When the second object passes through the first traffic signal light intersection 610 and the first traffic signal light is the green light 611 (i.e., the later green light stage), the second traffic signal light is red light 623 (i.e., the red light stage) when the second object arrives the second traffic signal light intersection 620, and the third traffic signal light is red light 633 (i.e., the red light stage) when the second object arrives the third traffic signal light intersection 630. At this time, the travel time length for the second object traveling along the movement trajectory 650 may be T2.

As shown in FIG. 6, when the moving distance of the first object and the second object are the same or the equivalent, and the speed for passing through the road section is the same or equivalent, T1 may be much smaller than T2. It may be seen that the stage of the traffic signal light 130 when the object 140 enters the traffic signal light intersection may have a great impact on the time length for the object 140 to pass through the traffic signal light intersection. Combined with specific one or more traffic signal light setting rules, when the object 140 enters the first traffic signal light intersection, and the first traffic signal light is in the initial green light stage, the time length for the object 140 to pass through the road section to be predicted may be short; when the object 140 enters the first traffic signal light intersection and the first traffic signal light is in the later green light stage, the time length for the object 140 to pass through the road section to be predicted may be relatively long.

In some embodiments, the prediction module 330 may predict the time length for the object 140 to pass through the region of the road section except the range of the traffic signal light intersection of the road section to be predicted (also referred to as non-traffic signal light intersection). The non-traffic signal light intersection refers to a portion of the road section between two consecutive traffic signal light intersections (denoted as the previous traffic signal light and the next traffic signal light), that is, a road section between the geographic location when the object 140 leaves the previous traffic signal light intersection and a geographic location when the object 140 enters the next traffic signal light intersection, the distance of which is denoted as S2. The object 140 leaving the traffic signal light intersection refers to that the object 140 leaves a preset range (e.g., three hundred meters) of the road section where the intersection is located. For example, when the object 140 leaves a traffic signal light intersection on a certain road section when the object 140 is 300 meters away from the stop line, the object 140 may have left the traffic signal light intersection. As another example, when the object 140 is out of a range-extending 300 meters from the center of the intersection, the object 140 may have left the traffic signal light intersection. As still another example, when the object 140 leaves the range determined by the traffic indication line on the road surface, the object 140 may have left the traffic signal light intersection.

In some embodiments, the prediction module 330 may predict the time length for the object 140 to pass through the non-traffic signal light intersection of the road section to be predicted based on the traffic state information of the non-traffic signal light intersection. The traffic state information may include traffic jam information, historical trajectory data, and the movement speed of the object 140, such as the current movement speed (denoted as Vc).

For example, the prediction module 330 may predict the movement speed of the object 140 (denoted as Vp) based on the traffic jam information. Then, based on S2 and Vp, the prediction module 330 may predict the time length for the object 140 to pass through the non-traffic signal light intersection of the road section to be predicted.

As another example, the prediction module 330 may predict the time length for the object 140 to pass through the non-traffic signal light intersection of the road section to be predicted based on historical trajectory data (e.g., the movement trajectory of the object). For example, the prediction module 330 may predict the time length for the object 140 to pass through the non-traffic signal light intersection of the road section to be predicted at the same specific time according to the historical time length for the object 140 to pass through the non-traffic signal light intersection of the road section to be predicted at a specific time. In some embodiments, the historical time length may be the travel duration in the past period (e.g., one week, half a month, one month, one quarter). In some embodiments, the historical time length corresponding to a specific time may be related to a specific date. For example, the historical time length corresponding to 15:00 on May 1, 2018 (e.g., Labor Day, Wednesday) may be related to the travel durations on May 1, 2017, and/or April 24 (that is, last Wednesday). As another example, the historical time length corresponding to 18:00 on Friday may be related to the travel duration of 18:00 on each Friday in the past month.

As another example, the prediction module 330 may directly predict the time length for the object 140 to pass through the non-traffic signal light intersection of the road section to be predicted based on the current movement speed Vc of the object 140. For example, the prediction module 330 may predict the time length for the object 140 to pass through the non-traffic signal light intersection of the road section to be predicted based on S2 and Vc.

Accordingly, the prediction module 330 may respectively predict the time length for the object 140 to pass through the traffic signal light intersection of the road section to be predicted and the time length for the object 140 to pass through the non-traffic signal light intersection of the road section to be predicted, thereby predicting the total time length for the object 140 to pass through the road section to be predicted.

In some embodiments, the total road section may be divided into multiple sections to be predicted (i.e., a plurality of sub-road sections). The prediction module 330 may predict the travel time of the total road section to be predicted based on the travel time of each road section.

In some embodiments, the prediction module 330 may dynamically update the travel time of the road section. For example, when the movement speed of the object 140 (e.g., Vp and Vc), the traffic jam information of the road section, and the historical trajectory data change, the prediction module 330 may dynamically update the travel time of the road section based on the changed movement speed of the object 140, the changed traffic jam information of the road section, and the changed historical trajectory. As another example, the prediction module 330 may dynamically update the travel time of the road section periodically.

In some embodiments, the prediction module 330 may determine the travel time for the object to pass through the road section based on a travel time prediction model. The travel time prediction model may be a machine learning model, for example, a neural network model obtained after training based on historical traffic information state information generated by all objects passing through the road section within a period (e.g., within a week), including but not limited to historical traffic jam information, historical trajectory data of objects, cycles of traffic signal lights, historical movement speeds of the objects, historical travel times for the objects to pass through the road section, or the like, or a combination thereof. The training process of the travel time prediction model may be executed by the training module 350. The training module 350 may use the historical traffic state information to train the travel time prediction model. The training process of the travel time prediction model may include a plurality of iterations. When a preset condition is reached, for example, the count of iterations reaches a preset value or the model converges (e.g., the value of a loss function is less than the preset value), the final travel time prediction model may be output. In some embodiments, the training module 350 may also use data generated when the objects pass through the sub-road section, for example, travel times, traffic jam information, trajectory data, cycles of traffic signal lights, movement speeds, etc., to update the travel time prediction model.

The sending module 340 may send information. In some embodiments, the sending module 340 may send prompt information to the object 140. For example, when the prediction module 330 predicts that the traffic signal light at a traffic signal light intersection that the object 140 is about to enter is in the red light stage, the sending module 340 may send prompt information to the object 140 to remind the object 140 that the traffic signal light at the traffic signal light intersection that the object 140 is about to enter is in the red light stage. As another example, when congestion occurs in the current road section, the sending module 340 may send prompt information to the object 140, prompting that the object 140 is about to enter the congested road section.

It should be noted that the description of system 300 for predicting travel time is for illustrative purposes and is not used to limit the protection scope of the present disclosure. For those skilled in the art, many variations and modifications may be made under the instructions of the present disclosure. However, these variations and modifications will not depart from the scope of protection of the present disclosure. For example, the prediction module 330 may predict the time length for the object 140 to pass through the traffic signal light intersection of the road section to be predicted based on the traffic jam information of the traffic signal light intersection, historical trajectory data, and the movement speed of the object 140. As another example, the prediction module 330 may make an overall prediction of the travel time of the road section to be predicted, instead of dividing the travel time of the road section to be predicted into the time length for the object 140 to pass through the traffic signal light intersection of the road section to be predicted and the time length for the object 140 to pass through the non-traffic signal light intersection of the road section to be predicted.

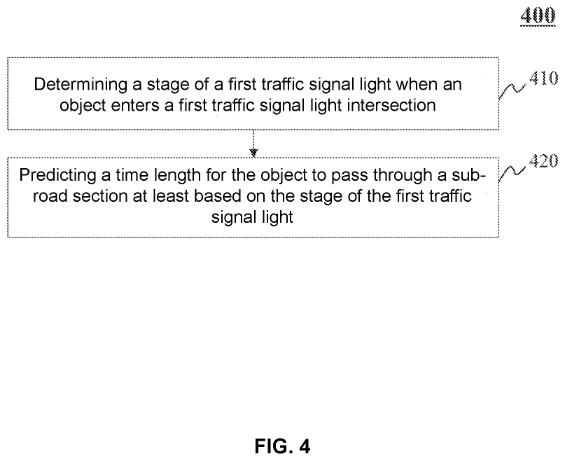

FIG. 4 is a flow chart illustrating an exemplary process for travel time prediction according to some embodiments of the present disclosure. The process 400 for travel time prediction may be executed by the travel time prediction system 300. As shown in FIG. 4, the process 400 for travel time prediction may include operations as follows.

In 410, the determination module 320 may determine a stage of a first traffic signal light when the object 140 enters a first traffic signal light intersection.

In some embodiments, the determination module 320 may determine the stage of the first traffic signal light 130 when the object 140 enters the first traffic signal light intersection at least based on the initial time when the object 140 starts to move on the sub-road section. The sub-road section may be used as a road section to be predicted, and the sub-road section may include the first traffic signal light intersection.

For example, obtaining module 310 may obtain the initial time when the object 140 starts to move on the sub-road section. The determination module 320 may determine the stage of the first traffic signal light 130 when the object 140 enters the first traffic signal light intersection at least based on the initial time.

As another example, when the starting point of the sub-road section (e.g., the sub-road section mentioned above) is the first traffic signal light intersection, the initial time when the object 140 starts to move on the sub-road section is the time when the object 140 enters the first traffic signal light intersection. At this time, the determination module 320 may determine the stage of the traffic signal light 130 only according to the initial time when the object 140 starts to move on the sub-road section.

For the specific method of determining the stage of the traffic signal light 130, please refer to the related description of FIG. 3.

In 420, the prediction module 330 may predict a time length for the object 140 to pass through a sub-road section at least based on the stage of the first traffic signal light.

For the sake of description, the time length for the object 140 to pass through the sub-road section may be divided into the time length for the object 140 to pass through the traffic signal light intersection in the sub-road section and the time length for the object 140 to pass through the non-traffic signal light intersection in the sub-road section. Furthermore, the prediction module 330 may predict the time length for the object 140 to pass through the sub-road section by predicting the time length for the object 140 to pass through the traffic signal light intersection in the sub-road section and the time length when the object 140 passes through the non-traffic signal light intersection in the sub-road section.

In some embodiments, the sub-road section may include a traffic signal light intersection. The prediction module 330 may predict the time length for the object 140 to pass through the traffic signal light intersection in the sub-road section based on the stage of the traffic signal light when the object 140 enters the traffic signal light intersection.

In some embodiments, the sub-road section may include two traffic signal light intersections, denoted as a first traffic signal light intersection and a second traffic signal light intersection. The prediction module 330 may predict the time length for the object 140 to pass through the first traffic signal light intersection based on the stage of the first traffic signal light when the object 140 enters the first traffic signal light intersection. Further, the prediction module 330 may predict the stage of the second traffic signal light when the object 140 enters the second traffic signal light intersection based on the stage of the first traffic signal light when the object 140 enters the first traffic signal light intersection. Then, the prediction module 330 may predict the time length for the object 140 to pass through the second traffic signal light intersection based on the stage of the second traffic signal light when the object 140 enters the second traffic signal light intersection. Based on the time length for the object 140 to pass through the first traffic signal light intersection and the second traffic signal light intersection, the prediction module 330 may predict the time length for the object 140 to pass through the traffic signal light intersection in the sub-road section.

In some embodiments, the sub-road section may include three or more traffic signal light intersections, denoted as the first traffic signal light intersection, the second traffic signal light intersection, the third traffic signal light intersection, . . . , the N−1th traffic signal light intersection, the Nth traffic signal light intersection. The prediction module 330 may predict the stage of the second traffic signal light when the object 140 enters the second traffic signal light intersection based on the stage of the first traffic signal light when the object 140 enters the first traffic signal light intersection. The prediction module 330 may predict the stage of the third traffic signal light when the object 140 enters the third traffic signal light intersection based on the stage of the second traffic signal light when the object 140 enters the second traffic signal light intersection. By analogy, the prediction module 330 may predict the stage of the N-th traffic signal light when the object 140 enters the Nth traffic signal light intersection based on the stage of the (N−1)th traffic signal light when the object 140 enters the (N−1)th traffic signal light intersection. The prediction module 330 may predict the time length for the object 140 to pass through each traffic signal light intersection based on the stage of each traffic signal light, and then predict the time length for the object 140 to pass through the traffic signal light intersection in the sub-road section.

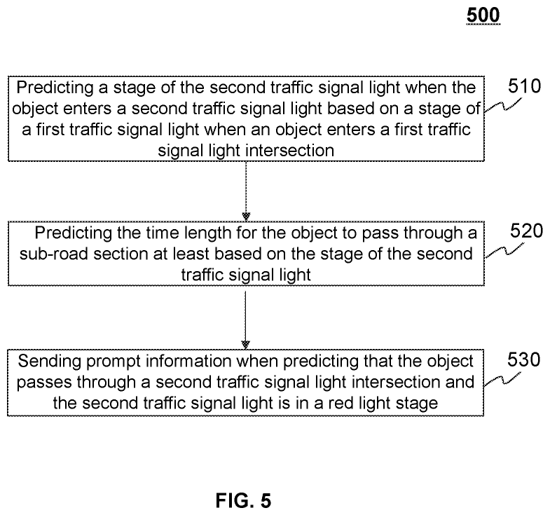

The above prediction based on the stage of the front traffic signal light (e.g., the first traffic signal light) when the object 140 enters the intersection of the previous traffic signal light and the stage of the next traffic signal light (e.g., the second traffic signal light) when the object 140 enters the intersection of the next traffic signal light may be referred to the related description of FIG. 3 and FIG. 5.

The time length for object 140 to pass through each traffic signal light intersection may be referred to the related description of FIG. 3.

In some embodiments, the prediction module 330 may predict the time length for the object 140 to pass through the non-traffic signal light intersection in the sub-road section. The prediction module 330 may predict the time length for the object 140 to pass through the non-traffic signal light intersection in the sub-road section based on the traffic jam information of the non-traffic signal light intersection, historical trajectory data, and the current movement speed of the object 140. Please refer to the related description of FIG. 3 for the specific prediction time length for the object to pass through the non-traffic signal light intersection in the sub-road section.

Accordingly, the prediction module 330 may respectively predict the time length for the object 140 to pass through the traffic signal light intersection in the sub-road section and the time length for the object 140 to pass through the non-traffic signal light intersection in the sub-road section, thereby predicting the total time length for the object 140 to pass through the sub-road section.

In some embodiments, the prediction module 330 may predict the travel time for the object to pass through the sub-road section based on the travel time prediction model and the stage of the traffic signal light when the object passes through the sub-road section. The travel time prediction model may be obtained after training by the training module 350 based on historical data. In some embodiments, the historical data may be historical traffic state information of objects passing through the road section, including but not limited to historical traffic jam information, historical trajectory data of objects, cycles of traffic signal lights, historical movement speeds of the objects, and object passing through the road section, historical travel time, or the like, or a combination thereof. The historical traffic jam information may be the traffic congestion situation of the road section within a specific period (e.g., one day, one week, etc.) in the past. The historical trajectory data of objects may be trajectory data of all objects passing through the road section within a specific period in the past (e.g., a day, a week, etc.). The cycle of the traffic signal light may be the cycle of the traffic signal light of the road section. The historical movement speeds of the objects may be the speed and change of each object passing through the road section within a specific period in the past (e.g., one day, one week, etc.). In some embodiments, the travel time prediction model may be a machine learning model, including but not limited to Support Vector Machine (SVM), Naive Bayes (Naive Bayes, NB), k nearest neighbor (k-Nearest Neighbor, KNN), Decision Tree (DT), Artificial Neural Network (ANN), or the like, or a combination thereof. The training module 350 may use the historical traffic state information as an input to train the model. When the model meets certain conditions, for example, the count of training times reaches a predetermined value and/or the model converges, the training may be stopped. The trained model may be designated as the travel time prediction model.

In some embodiments, the prediction module 330 may input the stage of the traffic signal light when the object passes through the road section and the initial time where the object starts to move on the sub-road section into the travel time prediction model to directly obtain the required travel time of the object. For a total road section with multiple sub-road sections, the prediction module 330 may separately predict the time length for the object to pass through each sub-road section based on the travel time model, and finally obtain the total time length for passing through the total road section.

In some embodiments, after the object passes through the road section, the training module 350 may obtain data generated during the movement of the object, such as travel time, traffic jam information, trajectory data, cycles of traffic signal lights, movement speed, etc. Every specific time (e.g., one day), the training module 350 may update the travel time prediction model by using the above-mentioned data of the objects passing through the road section obtained during this time to improve the accuracy of the model prediction. In some embodiments, the above-mentioned sub-road section may be a road section selected by the obtaining module 310 from candidate movement trajectory based on the current movement trajectory of the object 140.

In some embodiments, the above-mentioned sub-road section may be a part of the total road section divided by the obtaining module 310.

It should be noted that the above description of the process 400 for travel time prediction is only for the convenience of description, and does not limit the present disclosure within the scope of the cited embodiments. It may be understood that for those skilled in the art, after understanding the principle of the method, many variations and modifications may be made without departing from this principle. However, these variations and modifications will not depart from the scope of protection of the present disclosure. For example, the prediction module 330 may dynamically update the time length for the object 140 to pass through the sub-road section. As another example, the prediction module 330 may predict the overall travel time of the sub-road sections instead of separately predicting the time length for the object 140 to pass through the traffic signal light intersection in the sub-road section and the time length for the object 140 to pass through the non-traffic signal light intersection in the sub-road section.

FIG. 5 is a flow chart illustrating an exemplary process for travel time prediction according to some embodiments of the present disclosure. The process 500 for travel time prediction may be executed by the travel time prediction system 300. The process 500 for travel time prediction may be a further development of the process 400 for travel time prediction. As shown in FIG. 5, the process 500 for travel time prediction may include:

In 510, the prediction module 330 may predict a stage of the second traffic signal light when the object 140 enters a second traffic signal light based on the stage of the first traffic signal light when the object 140 enters a first traffic signal light intersection. The first traffic signal light intersection and the second traffic signal light intersection may be two adjacent traffic signal light intersections or two non-adjacent traffic signal light intersections.

As mentioned above, a specific time corresponds to a specific phase of a traffic signal light. In some embodiments, the above prediction of the stage of the second traffic signal light when the object 140 enters the second traffic signal light intersection based on the stage of the first traffic signal light when the object 140 enters the first traffic signal light intersection may be equivalent to the prediction of the corresponding time for the object 140 to enter the second traffic signal light intersection based on the corresponding time for the object 140 to enter the first traffic signal light intersection. For example, the prediction module 330 may predict the time length for the object 140 to move from the first traffic signal light intersection to the second traffic signal light intersection based on the current speed (or predicted speed) of the object 140 and the distance between the first traffic signal light intersection and the second traffic signal light intersection. Combined with the corresponding time when the object 140 enters the first traffic signal light intersection and the predicted time length for the object 140 to pass through the first traffic signal light intersection, the prediction module 330 may predict the time corresponding to the object 140 entering the second traffic signal light intersection. Furthermore, the prediction module 330 may predict the stage of the second traffic signal light when the object 140 enters the second traffic signal light intersection.

In some embodiments, the above-mentioned first traffic signal light and the second traffic signal light may be set according to specific one or more traffic signal light setting rules. For example, the one or more traffic signal light setting rules may be, both of the first traffic signal light and the second traffic signal light include three phases, such as a green light phase, a yellow light phase, and a red light phase. When the first traffic signal light is in the initial green light stage, the second traffic signal light is in the later red light stage. When the first traffic signal light is in the later green light stage, the second traffic signal light is in the initial red light stage. When the object 140 moves at a preset speed, the prediction module 330 may predict the following predictions. When the object 140 passes through the first traffic signal light intersection and the first traffic signal light is in the initial green light stage, the object 140 may pass through the second traffic signal light intersection and the second traffic signal light may be in the green light stage. When the object 140 passes through the first traffic signal light intersection, and the first traffic signal light is in the later green light stage, the object 140 passes through the second traffic signal light intersection and the second traffic signal light is in the red light stage.

For the specific method of predicting the stage of the second traffic signal light when the object 140 enters the second traffic signal light intersection, refer to the related description of FIG. 3.

In 520, the prediction module 330 may predict the time length for the object 140 to pass through the sub-road section at least based on the stage of the second traffic signal light.

For the sake of description, the time length for the object 140 to pass through the sub-road section may be divided into the time length for the object 140 to pass through the traffic signal light intersection in the sub-road section and the time length for the object 140 to pass through the non-traffic signal light intersection in the sub-road section. Furthermore, the prediction module 330 may predict the time length for the object 140 to pass through the sub-road section by predicting the time length for the object 140 to pass through the traffic signal light intersection in the sub-road section and the time length for the object 140 to pass through the non-traffic signal light intersection in the sub-road section.

In some embodiments, the above-mentioned sub-road sections may only include the first traffic signal light intersection and the second traffic signal light intersection. The prediction module 330 may predict the time length for the object 140 to pass through the first traffic signal light intersection based on the stage of the first traffic signal light when the object 140 enters the first traffic signal light intersection. Then, the prediction module 330 may predict the time length for the object 140 to pass through the second traffic signal light intersection based on the stage of the second traffic signal light when the object 140 enters the second traffic signal light intersection. Based on the time length for the object 140 to pass through the first traffic signal light intersection and the second traffic signal light intersection, the prediction module 330 may predict the time length for the object 140 to pass through the traffic signal light intersection in the sub-road section.

In some embodiments, the above-mentioned sub-road sections may include a first traffic signal light intersection, a second traffic signal light intersection, and other traffic signal light intersections. Other traffic signal light intersections may be denoted as the third traffic signal light intersection, . . . , the N−1th traffic signal light intersection, and the Nth traffic signal light intersection. The prediction module 330 may predict the stage of the third traffic signal light when the object 140 enters the third traffic signal light intersection based on the stage of the second traffic signal light when the object 140 enters the second traffic signal light intersection. By analogy, the prediction module 330 may predict the stage of the Nth traffic signal light when the object 140 enters the Nth traffic signal light intersection based on the stage of the (N−1)th traffic signal light when the object 140 enters the (N−1)th traffic signal light intersection. The prediction module 330 may predict the time length for the object 140 to pass through each traffic signal light intersection based on the stage of each traffic signal light, and then predict the time length for the object 140 to pass through the traffic signal light intersection in the sub-road section.

The time length for the object 140 to pass through each traffic signal light intersection may be referred to the related description of FIG. 3.

In some embodiments, the prediction module 330 may predict the time length for the object 140 to pass through the non-traffic signal light intersection in the sub-road section. The prediction module 330 may predict the time length for the object 140 to pass through the non-traffic signal light intersection in the sub-road section based on the traffic jam information of the non-traffic signal light intersection, historical trajectory data, and the current movement speed of the object 140. Please refer to the related description of FIG. 3 for the specific prediction time for the object to pass through the non-traffic signal light intersection in the sub-road section.

Accordingly, the prediction module 330 may respectively predict the time length for the object 140 to pass through each traffic signal light intersection in the sub-road section and the time length for the object 140 to pass through the non-traffic signal light intersection in the sub-road section, thereby predicting the total time length for the object 140 to pass through the sub-road section.

In 530, when predicting that the object 140 passes through a second traffic signal light intersection and the second traffic signal light is in a red light stage, the sending module 340 sends prompt information. The prompt information may include a traffic signal light that prompts that the second traffic signal light intersection that the object 140 is about to enter is in the red light stage.

It should be noted that the foregoing description of the process 500 for travel time prediction is only for the convenience of description, and does not limit the present disclosure within the scope of the embodiments mentioned. It may be understood that, for those skilled in the art, after understanding the principle of the method, many variations and modifications may be made without departing from this principle. However, these variations and modifications will not depart from the scope of protection of the present disclosure. For example, the prediction module 330 may dynamically update the time length for the object 140 to pass through the sub-road section. As another example, the prediction module 330 may predict the overall travel time of the sub-road sections instead of separately predicting the time length for the object 140 to pass through the traffic signal light intersection in the sub-road section and the time length for the object 140 to pass through the non-traffic signal light intersection in the sub-road section. As another example, step 530 may be omitted.

Compared with the prior art, the possible beneficial effects of the embodiments of the present disclosure include but are not limited to:

1. For the road section to be predicted including the traffic signal light intersection, at least based on the stage of the traffic signal light when the object enters the traffic signal light intersection, when the travel time for the object to pass through the road section to be predicted is predicted, the travel time prediction is more accurate.

2. Construct a travel time prediction model based on historical trajectory data, and combine the stage of traffic signal light when the object enters the traffic signal light intersection to accurately predict the travel time for the object to pass through the road section to be predicted.

3. Realize the time prediction of long-distance travel and non-straight road sections by segmenting the travel.

It should be noted that different embodiments may have different beneficial effects. In different embodiments, the possible beneficial effects may be any one or a combination of the above, or any other beneficial effects that may be obtained.

The basic concepts have been described above. Obviously, to those skilled in the art, the disclosure of the invention is merely by way of example and does not constitute a limitation on the present disclosure. Although not explicitly stated here, those skilled in the art may make various modifications, improvements, and amendments to the present disclosure. Such modifications, improvements, and amendments are suggested in the present disclosure, so such modifications, improvements, and amendments still belong to the spirit and scope of the exemplary embodiments of the present disclosure.

Moreover, certain terminology has been configured to describe embodiments of the present disclosure. For example, “one embodiment”, “an embodiment”, and/or “some embodiments” mean a certain feature, structure, or characteristic related to at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. Besides, some features, structures, or features in the present disclosure of one or more embodiments may be appropriately combined.

Besides, those skilled in the art may understand that various aspects of the present disclosure may be illustrated and described through some patentable categories or situations, including any new and useful process, machine, product, or combination of substances, or any new and useful improvements. Accordingly, all aspects of the present disclosure may be performed entirely by hardware, may be performed entirely by software (including firmware, resident software, microcode, etc.), or may be performed by a combination of hardware and software. The above hardware or software may be referred to as “data block”, “module”, “engine”, “unit”, “component” or “system”. Besides, aspects of the present disclosure may appear as a computer product located in one or more computer-readable media, the product including computer-readable program code.

The computer-readable signal medium may include a propagated data signal containing a computer program code, for example on baseband or as part of a carrier wave. The propagation signal may have multiple manifestations, including electromagnetic, optical, etc., or a suitable combination. The computer-readable signal medium may be any computer-readable medium except a computer-readable storage medium, and the medium may be connected to an instruction execution system, apparatus, or device to realize communication, propagation, or transmission of the program for use. The program code located on the computer-readable signal medium may be propagated through any suitable medium, including radio, cable, fiber optic cable, RF, or similar medium, or any combination of the above medium.

The computer program codes required for the operations of each part of the present disclosure may be written in any one or more programming languages, including object-oriented programming languages such as Java, Scala, Smalltalk, Eiffel, JADE, Emerald, C++, C#, VB.NET and Python, or the like. The program code may run entirely on the user's computer, or run as an independent software package on the user's computer, or partly run on the user's computer and partly run on the remote computer, or run entirely on the remote computer or server. In the latter case, the remote computer may be connected to the user's computer through any network, such as a local area network (LAN) or a wide area network (WAN), or connected to an external computer (e.g., via the Internet), or in a cloud computing environment, or as a service software as a service (SaaS).

Besides, unless explicitly stated in the claims, the order of processing elements and sequences, the use of numbers and letters, or the use of other names in the present disclosure are not configured to limit the order of the procedures and methods of the present disclosure. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped in a single embodiment, figure, or description thereof to streamline the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

Some examples use numbers describing the number of ingredients and attributes. It should be understood that such numbers used in the description of the examples use the modifier “about”, “approximately” or “substantially” in some examples. Unless otherwise stated, “approximately”, “approximately” or “substantially” indicates that the number is allowed to vary by ±20%. Correspondingly, in some embodiments, the numerical parameters used in the specification and claims are approximate values, and the approximate values may be changed according to the required characteristics of individual embodiments. In some embodiments, the numerical parameter should consider the prescribed effective digits and adopt the general digit retention method. Although the numerical ranges and parameters configured to confirm the breadth of the ranges in some embodiments of the present disclosure are approximate values, in specific embodiments, the setting of such numerical values is as accurate as possible within the feasible range.

For each patent, application, publication, and other materials cited in the present disclosure, such as articles, books, specifications, publications, documents or objects, etc., the entire contents are hereby incorporated into the present disclosure as a reference. Except for the present disclosure history documents that are inconsistent or conflicting with the content of the present disclosure, and the documents that restrict the broadest scope of the claims of the present disclosure (currently or later attached to the present disclosure) are also excluded. It should be noted that if there is any inconsistency or conflict between the description, definition, and/or term usage in the supplementary materials of the present disclosure and the content described in the present disclosure, the description, definition, and/or term usage of the present disclosure shall prevail.

At last, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized by the teachings herein. Accordingly, embodiments of the present disclosure are not limited to that precisely as shown and described.

1. A method for predicting travel time, comprising:
determining a stage of a first traffic signal light when an object enters a first traffic signal light intersection;
based on the stage of the first traffic signal light, predicting a stage of a second traffic signal light when the object passes through a second traffic signal light intersection;
predicting a time length for the object to pass through a sub-road section at least based on the stage of the first traffic signal light and the stage of the second traffic signal light;
wherein a cycle of a traffic signal light includes at least two stages, and the sub-road section includes the first traffic signal light intersection and the second traffic signal light intersection.

2. The method of claim 1, wherein the determining the stage of the first traffic signal light when the object enters the first traffic signal light intersection includes:
obtaining an initial time of the object moving on the sub-road section and a cycle of the first traffic signal light;
determining the stage of the first traffic signal light when the object enters the first traffic signal light intersection at least based on the initial time and the cycle of the first traffic signal light.

3. The method of claim 2, wherein a starting point of the sub-road section is the first traffic signal light intersection, and the initial time is a time when the object enters the first traffic signal light intersection.

4. (canceled)

5. The method of claim 1, wherein
the cycle of the traffic signal light includes at least a red light stage and a green light stage;
the method further includes:
sending prompt information in response to a prediction that the second traffic signal light is in the red light stage when the object passes through the second traffic signal light intersection, wherein the prompt information includes that the second traffic signal light is in the red light stage.

6. The method of claim 1, wherein the based on the stage of the first traffic signal light, predicting the stage of the second traffic signal light when the object passes through the second traffic signal light intersection includes:
based on the stage of the first traffic signal light and one or more traffic signal light setting rules for setting the first traffic signal light and the second traffic signal light, predicting the stage of the second traffic when the object passes through the second traffic signal light intersection.

7. The method of claim 1, wherein
the cycle of the traffic signal light includes at least a red light stage and a green light stage, and the green light stage includes at least an initial green light stage and a later green light stage;
the method further includes:
in response to a determination that the first traffic signal light is in the initial green light stage when the object enters the first traffic signal light intersection, predicting that the second traffic signal light is in the green stage when the object passes through the second traffic signal light intersection;
in response to a determination that the first traffic signal light is in the later green light stage when the object enters the first traffic signal light intersection, predicting that the second traffic signal light is in the red stage when the object passes through the second traffic signal light intersection.

8. The method of claim 1, wherein the method further includes:
obtaining traffic state information of the sub-road section; the traffic state information including at least one of traffic jam information, historical trajectory data of objects on the sub-road section, or a movement speed of the object;
at least based on the stage of the first traffic signal light and the traffic state information, predicting the time length for the object to pass through the sub-road section.

9. The method of claim 1, wherein the method further includes:
obtaining historical traffic state information passing through a total road section; the historical traffic state information including at least one of historical traffic jam information, historical trajectory data of objects, cycles of traffic signal lights, historical movement speeds of the objects, the historical travel time of the objects passing through the total road section; the total road section including at least one sub-road section, and each sub-road section including at least one traffic signal light intersection;
based on the historical traffic state information, determining a travel time prediction model;
at least based on stages of the traffic signal lights when the object passes through each sub-road section and the travel time prediction model, predicting the travel time for the object to pass through the total road section.

10. The method of claim 9, wherein the method further includes:
at least based on the travel time for the object to pass through the total road section, dynamically updating the travel time prediction model.

11. The method of claim 1, wherein the method further includes:
obtaining a candidate movement trajectory of the object;
based on the current movement trajectory of the object, selecting the sub-road section from the candidate movement trajectory.

12. The method of claim 1, wherein the method further includes:
dividing a total road section into a plurality of sub-road sections, at least one sub-road section of the plurality of sub-road sections including at least one traffic signal light intersection;
based on the travel time of each sub-road section, predicting the travel time of the total road section.

13. The method of claim 12, wherein the method further includes:
dynamically updating the travel time of the total road section.

14-26. (canceled)

27. A computer-readable storage medium storing instructions, when the instructions are executed, comprising:
determining a stage of a first traffic signal light when an object enters a first traffic signal light intersection;
based on the stage of the first traffic signal light, predicting a stage of a second traffic signal light when the object passes through a second traffic signal light intersection;
predicting a time length for the object to pass through a sub-road section at least based on the stage of the first traffic signal light and the stage of the second traffic signal light;
wherein a cycle of a traffic signal light includes at least two stages, and the sub-road section includes the first traffic signal light intersection and the second traffic signal light intersection.

28. A device for predicting travel time, comprising a processor, wherein the processor executing following method and configured to:
determine a stage of a first traffic signal light when an object enters a first traffic signal light intersection;
based on the stage of the first traffic signal light, predict a stage of a second traffic signal light when the object passes through a second traffic signal light intersection;
predict a time length for the object to pass through a sub-road section at least based on the stage of the first traffic signal light and the stage of the second traffic signal light;
wherein a cycle of a traffic signal light includes at least two stages, and the sub-road section includes the first traffic signal light intersection and the second traffic signal light intersection.

29. The device of claim 28, wherein the determining the stage of the first traffic signal light when the object enters the first traffic signal light intersection includes:
obtaining an initial time of the object moving on the sub-road section and a cycle of the first traffic signal light;
determining the stage of the first traffic signal light when the object enters the first traffic signal light intersection at least based on the initial time and the cycle of the first traffic signal light.

30. The device of claim 28, wherein
the cycle of the traffic signal light includes at least a red light stage and a green light stage;
the device is further configured to:
send prompt information in response to a prediction that the second traffic signal light is in the red light stage when the object passes through the second traffic signal light intersection, wherein the prompt information includes that the second traffic signal light is in the red light stage.

31. The device of claim 28, wherein the based on the stage of the first traffic signal light, predicting the stage of the second traffic signal light when the object passes through the second traffic signal light intersection includes:
based on the stage of the first traffic signal light and one or more traffic signal light setting rules for setting the first traffic signal light and the second traffic signal light, predicting the stage of the second traffic when the object passes through the second traffic signal light intersection.

32. The device of claim 28, wherein
the cycle of the traffic signal light includes at least a red light stage and a green light stage, and the green light stage includes at least an initial green light stage and a later green light stage;
the processor is further configured to:
in response to a determination that the first traffic signal light is in the initial green light stage when the object enters the first traffic signal light intersection, predict that the second traffic signal light is in the green stage when the object passes through the second traffic signal light intersection;
in response to a determination that the first traffic signal light is in the later green light stage when the object enters the first traffic signal light intersection, predict that the second traffic signal light is in the red stage when the object passes through the second traffic signal light intersection.

33. The device of claim 28, wherein the processor is further configured to:
obtain historical traffic state information passing through a total road section; the historical traffic state information including at least one of historical traffic jam information, historical trajectory data of objects, cycles of traffic signal lights, historical movement speeds of the objects, the historical travel time of the objects passing through the total road section; the total road section including at least one sub-road section, and each sub-road section including at least one traffic signal light intersection;
based on the historical traffic state information, determine a travel time prediction model;
at least based on stages of the traffic signal lights when the object passes through each sub-road section and the travel time prediction model, predict the travel time for the object to pass through the total road section.

34. The device of claim 33, wherein the processor is further configured to:
at least based on the travel time for the object to pass through the total road section, dynamically updating the travel time prediction model.
